(19) United States
(12) Patent Application Publication
(10) Pub. No.: US 2006/0147593 A1
(43) Pub. Date: Jul. 6, 2006

(54) System and method for extracting materials from biomass

(76) Inventor: Doug Van Thorre, Minneapolis, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/031,670

(22) Filed: Jan. 6, 2005

(51) Int. Cl. A23P 1/00

(52) U.S. Cl. 426/518

(57) ABSTRACT

One embodiment described herein includes a method for biomass extraction. The method includes identifying core biomass structures; and identifying crystalline structural components of the biomass and amorphous structural components of the core biomass structures. The method embodiment also includes identifying which components are structurally related and which are cellularly related; and separating the crystalline structural components of the biomass from the amorphous structural components by grinding, wherein the core biomass structures are ground to a size approaching the size of crystals, including microcrystals, of the crystalline structural components.

### FIELD

Embodiments described herein relate to systems and methods for separating materials from biomass.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to any software and data as described below and in the drawings that form a part of this document: Copyright 2004, Biorefining, Inc. All Rights Reserved.

### BACKGROUND

Since time immemorial, biomass such as grains of wheat or kernels or corn, have been ground to make flour. In more recent times, biomass such as soybeans have been pressed to extract oil, while corn kernels have been steeped in water to separate bran. These types of processes have been developed without any regard for the elegant structures and architecture of the biomass. As a consequence, thousands of years of evolutionary development of the structures within the biomass has been ground, pounded, pressed out of existence in order to extract oil or flour.

### BRIEF DESCRIPTION OF FIGURES

FIG. 1 is a cross-sectional view of a corn kernel.

FIG. 2 is a schematic view of one method embodiment for separation of core components of a corn kernel.

FIG. 3 is a schematic view of a method for separation biomass components based upon their relationship with a membrane.

### SUMMARY

One embodiment described herein includes a method for biomass extraction. The method includes identifying core biomass structures; and identifying crystalline structural components of the biomass and amorphous structural components of the core biomass structures. The method embodiment also includes identifying which components are structurally related and which are cellularly related; and separating the crystalline structural components of the biomass from the amorphous structural components by grinding, wherein the core biomass structures are ground to a size approaching the size of crystals, including microcrystals, of the crystalline structural components.

### DETAILED DESCRIPTION

Methods, apparatus and systems for extraction of a variety of materials from biomass are described herein. In the following description, numerous specific details are set forth. However, it is understood that embodiments of the invention may be practiced without these specific details. In other instances, well-known circuits, processes, structures, and techniques have not been shown in detail in order to avoid obscuring the understanding of this description. Note that in the description, references to “one embodiment” or “an embodiment” mean that the feature being referred to is included in at least one embodiment of the invention. Further, separate references to “one embodiment” in this description do not necessarily refer to the same embodiment; however, neither such embodiments are mutually exclusive, unless so stated and except as will be readily apparent to those of ordinary skill in the art. Thus, the invention described herein may include any variety of combinations and/or integrations of the embodiments described herein. Moreover, in this description, the phrase “exemplary embodiment” means that the embodiment being referred to serves as an example or illustration.

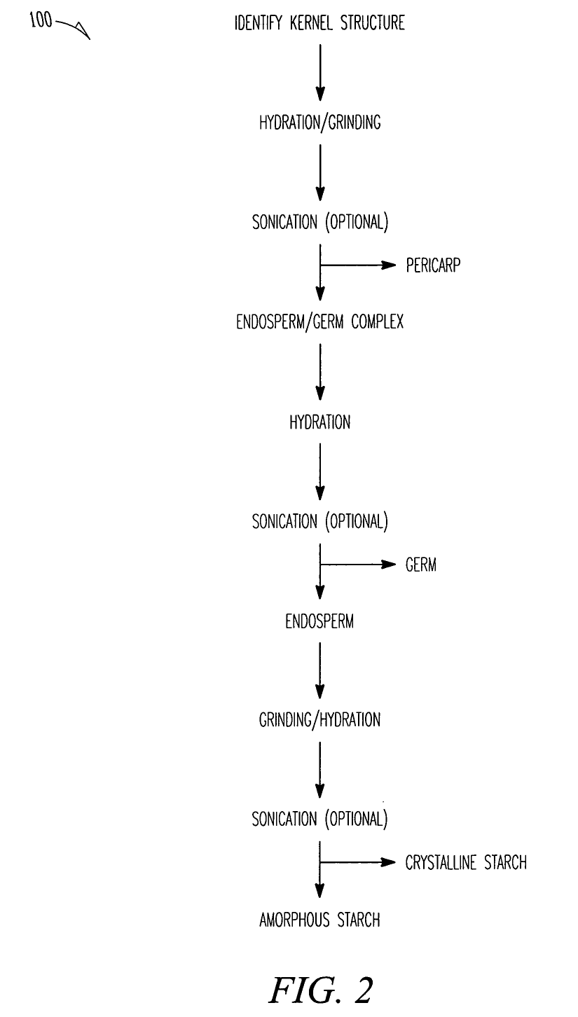

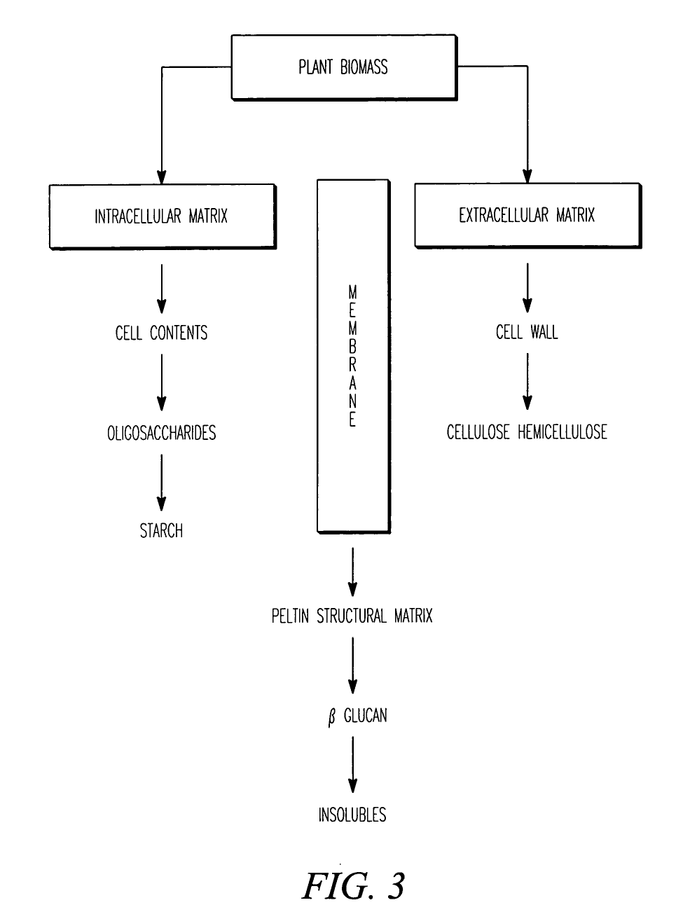

One method embodiment of the invention, illustrated at 100 in FIG. 2 for biomass extraction includes identifying core biomass physical structures and identifying crystalline structural components, amorphous structural components and intra-/extra-cellular components both crystalline and amorphous of the biomass, such as is shown in FIG. 3. Identifying the core biomass structures includes characterizing the architecture of the biomass in its physical, functional, mechanical and chemical aspects. In one exemplary embodiment, the core biomass components of a corn kernel are discussed herein. It is understood, however, that any biomass is capable of being characterized in the manner described herein.

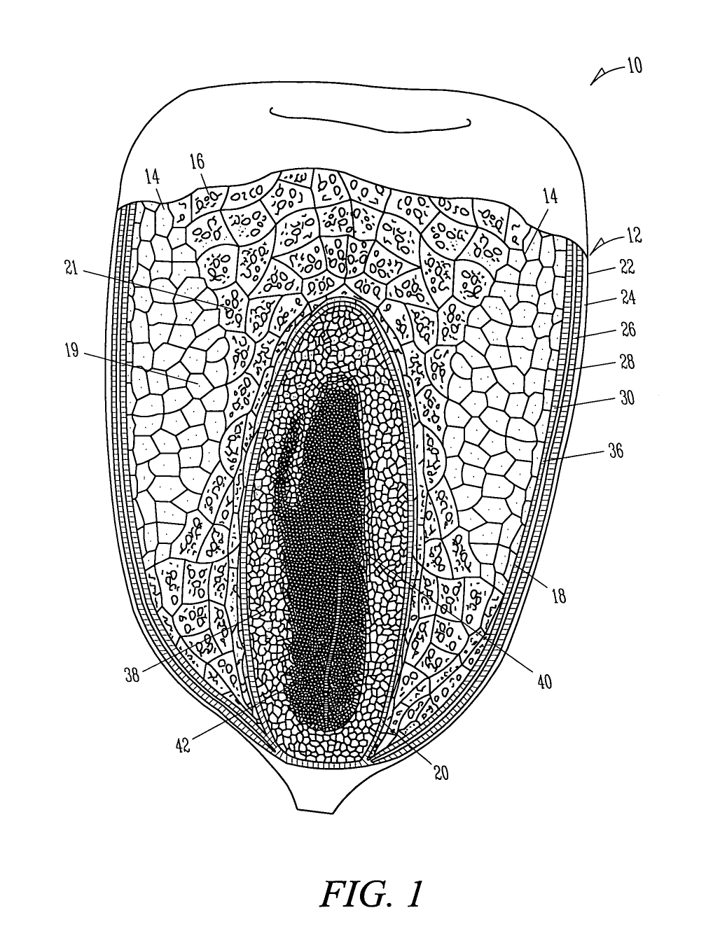

A corn kernel includes components such as a pericarp 12, endosperm 18, and germ 20. The pericarp 12 includes a plurality of outer layers that form a “coat” that protects the kernel. The pericarp 12 makes up about six percent of the kernel and includes about 73 percent of insoluble non-starch carbohydrate with 16 percent fiber, 7 percent protein and 2 percent oil. Specific components of the pericarp 12, shown in FIG. 1, include an epidermis 22, a mesocarp 24, cross cells 26, tube cells 28 a testa or seed coat 30 and an alaurone layer 36, which is part of the endosperm but separated with bran.

The endosperm 18 includes corn meal and comprises about 80 to 84 percent of the corn kernel. The endosperm contains about 85 percent starch and 12 percent protein. The kernel 10 includes both hard, horny, outer endosperm and soft, inner endosperm. The endosperm 18 includes a horny endosperm 19 and floury endosperm 21. The endosperm 18 also includes cells filled with starch granules in a protein matrix. The starch components include crystalline starch 14 and amorphous starch 16.

The corn kernel 10 also includes the germ 20 that makes up about 10 to 14 percent of the kernel. Most of the oil in the corn kernel, 81 to 86 percent, is in the germ. The germ 20 also includes protein and carbohydrate. The germ includes components such as a scutellum 38, plumela or rudimentary shoot or leaves 40 and radlcia or primary root 42. The germ 20 is the living component of the corn kernel 10.

Some method embodiments include identifying components for extraction. The components may be structural components such as the pericarp, endosperm, or germ, or cellular components such as crystalline starch or germ DNA or phospholipids, or both. The components are, for some embodiments, the native structures and chemicals of the kernel, substantially unchanged by processing.

For some embodiments, the method includes separating the crystalline structural components from the amorphous structural components by methods that include grinding. In particular, the core biomass structures are ground to a size approaching the size of crystals, including microcrystals, of the crystalline components. For other embodiments, biomass structures are broken down within predefined grinding ranges. By “broken down” it is meant that the components' physical structures are destroyed.

In one embodiment, the pericarp of the corn kernel is hydrated with water in a quantity that softens the pericarp. The water is added, for some embodiments, by spraying the pericarp so that the pericarp is hydrated without free or excess water. Once the pericarp is hydrated, the pericarp is subjected to grinding in order to separate the pericarp from the remaining kernel, which is the endosperm/germ complex. For some embodiments, the pericarp is separated from the endosperm/germ complex with grinding and ultrasonic exposure in order to make a clean separation while doing minimal damage to the remaining kernel chemical structure. With this embodiment, the “bran” component of the corn kernel is separated early in the biomass treatment process. The “bran” is, for some embodiments, separated first.

For some embodiments, the pericarp is hydrated with a protonated and/or hydroxylated clustered water, one source of which is IP3 Corp. For some embodiments, the pericarp is disrupted by cryogenic freezing. Once the pericarp is disrupted by one or more of hydration, grinding, clustered water or cryogenic freezing, specific components are extracted from the disrupted pericarp 12 using, for some embodiments, by sonication and selective solublization.

The separated pericarp 12 is, for some embodiments, further processed in order to extract specific materials as described below. The pericarp removal is performed in a manner that accommodates the symmetry of kernels of corn generally, and, for some embodiments, specific variations in symmetry of the kernels.

Once, the protective cover of the pericarp 12 is removed, the endosperm 18 including crystalline starch 14 and amorphous starch 16, along with the germ 20, is exposed. This portion of the corn kernel is the germ/endosperm (G/E) complex. The germ/endosperm complex is treated in order to separate the germ from the endosperm. In one embodiment, the germ/endosperm complex, is hydrated without forming significant free or excess water. In particular, the germ/endosperm complex is hydrated to a degree that softens the binder binding the germ to the endosperm. In one embodiment, the hydrated germ/endosperm complex is subjected to grinding in order to separate the germ from the endosperm. The grinding occurs after hydration for some embodiments and concurrent with hydration for other embodiments. For some embodiments, separation occurs with sonication. For some embodiments, hydration is performed using clustered water.

The crystalline starch 14 of the endosperm has been found to include microcrystals, about 40 microns in diameter, that include 35% starch and 65% protein. The crystalline starch microcrystals include layers of crystalline starch laid down like layers of a pearl. Within the pearl-like microcrystals are oil-bearing protein encapsulates.

The endosperm is ground to separate the crystalline starch from the amorphous starch. In one embodiment, the endosperm is ground to generate particles within a size range of 40 microns, the approximate size of the microcrystals in the crystalline starch. In one embodiment, the particles are ground to a 40 micron size plus or minus 5 microns. The grinding is, for some embodiments, performed in a microgrinder. One microgrinder usable in the process embodiments described herein is described in U.S. Pat. No. 5,410,021. With the microgrinder, the starch microcrystal integrity is maintained and the amorphous starch is separated from the starch microcrystals with, in one embodiment, sonication. While microgrinding is described, it is understood that grinders capable of grinding to sizes of 100 microns or less are suitable for embodiments described herein. For some embodiments, one or both of the fractions, starch microcrystals and amorphous starch, are saved for further treatment.

For other embodiments, the endosperm is ground to 75 to 80 microns to make a ground fraction. The ground fraction is solubilized in ethanol and sonicated for separation of the crystallized starch from the protein component. For other embodiments, the ground fraction is not sonicated. As a result, the microparticles of starch are extracted. The starch microparticles may be cross-linked and used as carriers for pharmaceuticals, nutraceuticals and other materials.

The germ fraction of the germ/endosperm complex is, for some embodiments, subjected to solubilizing and grinding to separate the nucleic acid, DNA and RNA, and protein from the remaining portion of the germ. The germ also includes oil, present in oil bodies within the germ. For some embodiments, oil in the oil bodies is non-destructively extracted by solubilizing the oil into a solvent fraction. For some embodiments, phospholipids are also extracted into a solvent fraction.

While a corn kernel is described, it is understood that method embodiments are usable to separate constituents of any biomass. The method includes identifying the architecture of the biomass, the core structures and the mechanisms that order the core structures within the biomass. The method also includes sequentially separating the core components without destroying core components. The separation includes grinding, for some embodiments, within a size range that is not less than the size of the selected core component. For some embodiments, the separation also includes sonication. For some embodiments, the separation includes hydration, in some instances, with clustered water.

Once the core components are separated, constituents or structures or both, within one or more of the core components are separated from the core component. In the case of a corn kernel, components such as the epidermis 22, mesocarp 24, cross cells 26, tube cells 28, testa 30, and alaurone layer 36 are, for some embodiments, separated from the pericarp 12. In one embodiment, in preparation of separation, the components are categorized as being structural components, intercellular components, or extracellular components. Other components of the pericarp may be separated using a combination of hydration without free water, microgrinding, sonication, cryogenic freezing and selective solublization.

The epidermis 22 and mesocarp 24 of a corn kernel are made of closely adherent, long and fibrous thick-walled cells with no intercellular spaces. These cells are resistant to crack and breakage. The aleurone layer, which is the outermost layer of the endosperm, contains no intercellular spaces. The aleurone layer contains protein and oil but no starch.

For some embodiments, the mesocarp 24 is separated from other components of the pericarp by sonication. Once the mesocarp is separated, for some embodiments, it is partially dried. Drying reduces the total moisture level from between 15% to 75% of the starting mesocarp moisture level. Any of a variety of times and temperatures may be used to dry the mesocarp product, as long as the product is not scorched or blistered, and an adequate amount of moisture is removed in a desired time period. The mesocarp product may be air dried or osmotically dried. One drying temperature range occurs between 200° F.-300° F., with the drying time ranging between 15 minutes and 45 minutes. An amount of a partially dried mesocarp product is thereby produced.

The dried pericarp is, for some embodiments, subjected to freezing, such as by cryogenic freezing, or is subjected to mechanical separation such as grinding and cryogenic freezing. Cryogenic freezing includes exposing the pericarp product to temperatures equal to approximately −321° F. (in liquid nitrogen) for about one minute. Liquid nitrogen or liquid carbon dioxide may be used. Cryogenic freezers are purchasable from any of a variety of commercial providers. Cryogenic freezing produces a fresh crisp product. It is believed that cryogenic freezing prevents water in the mesocarp product from expanding and thereby breaking the cell wall. Any method that maintains the cell wall integrity during freezing is usable. For some embodiments, the mesocarp is subjected to microgrinding for exposure of internal components such as phospholipids. Phospholipids are extracted from the mesocarp by extraction with ethanol in a microreactor, in some embodiments.

What is claimed is:

1. A method for biomass extraction, comprising:
identifying core biomass structures;
identifying crystalline structural components of the biomass and amorphous structural components of the core biomass structures;
identifying which components are structurally related and which are cellularly related; and
separating the crystalline structural components of the biomass from the amorphous structural components by grinding, wherein the core biomass structures are ground to a size approaching the size of crystals, including microcrystals, of the crystalline structural components.

2. The method of claim 1 wherein the grinding separates the crystalline structural components from the amorphous structural components.

3. The method of claim 2 wherein the crystalline structural components are maintained in their native structural state.

4. The method of claim 1, further comprising removing any protective outer covering from the core biomass structures.

5. The method of claim 4, wherein the protective outer covering is fibrous.

6. The method of claim 4, wherein the protective outer covering is removed, selectivity, by grinding with water in a quantity sufficient to hydrate and to soften the outer protective coating,

7. The method of claim 1, further comprising sonicating the core biomass structures.

8. The method of claim 4 wherein the protective outer covering is removed by subjecting the biomass to cryogenic cooling.

9. The method of claim 1 wherein starch microcrystals are separated from a germ endosperm complex.

10. The method of claim 9 wherein the germ is separated from the endosperm by hydrating the germ endosperm complex, grinding the hydrated complex with microgrinders and sonicating the germ endosperm complex to separate the germ from the endosperm.

11. The method of claim 1 wherein the structures identified include a cell membrane, extracellular region and intracellular region.

12. The method of claim 1, further comprising separating components based upon their selective solubility in water.

13. The method of claim 12, further comprising separating components based upon their solubility in solvents.

14. A system for biomass separation, comprising:
a grinder for separation an outer covering of biomass from inner components.

15. The system of claim 14, further comprising a sonicator.

16. The system of claim 14, further comprising a device for cryogenic freezing.

17. The system of claim 1, further comprising a device for hydrating biomass without excess water.
